(19) United States
(12) Patent Application Publication
(10) Pub. No.: US 2006/0113957 A1
(43) Pub. Date: Jun. 1, 2006

(54) Portable terminal and its control method

(75) Inventors: Fumiyuki Ito, Kanagawa (JP); Hiroki Matsumoto, Kanagawa (JP); Hirokazu Sato, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/288,835

(22) Filed: Nov. 28, 2005

(30) Foreign Application Priority Data
Nov. 29, 2004 (JP) P.2004-344429

(51) Int. Cl. H02J 7/00

(52) U.S. Cl. 320/114

(57) ABSTRACT

It is a portable terminal which can output contents from a communication network in a plurality of output modes easily. When a user performs a setting operation of the output conditions for each output mode using the operation unit, the browser setting unit stores the respective output conditions in the storing unit. The user gives the operation unit the instruction to display desired contents in a Web site as well as the instruction about the output mode, the mode switch reads out the output conditions of the instructed output mode from the storing unit and sets them into the browser. The browser searches for the desired contents by using the reference information of a designated Web site, obtains the source of the Web site with the desired contents, and produces the display data of the desired content taken from the source by using the output conditions which have been set.

### BACKGROUND OF THE INVENTION

1. Field of the Invention

The invention relates to improvement of a portable terminal capable of outputting contents over a communication network in a plurality of output modes and its control method.

2. Description of Related Art

Heretofore, there has been in practical use, a portable terminal which can output contents, including image and sound data, over a communication network like the Internet. For example, JP-A-2002-63016 discloses an example of a cellular phone which obtains and displays a home page through access to the Internet.

In the conventional technique, however, there has not been a portable terminal that can output contents over a communication network in a plurality of output modes. When the portable terminal tries to output a content in a plurality of output modes, a browser needs to change various settings for the new output mode, which is a troublesome operation.

### SUMMARY OF THE INVENTION

The invention is intended to solve the above problem and one of its objects is to provide a portable terminal and a control method of the portable terminal which can easily output contents over a communication network in a plurality of output modes.

In order to achieve the above object, one mode of the invention is a portable terminal capable of outputting contents over a communication network in a plurality of output modes, comprising: an output condition setting unit which sets output conditions for every output mode; a mode switching unit which switches the output modes; and an output unit which outputs a desired content according to the output conditions set in the output mode when the output modes are switched.

The portable terminal according to one mode of the invention further comprises a storing unit which stores the set output conditions for every output mode, so that when the output mode is switched by the mode switching unit, the outputted content is changed according to the output conditions stored in the storing unit.

In the portable terminal according to one mode of the invention, the output conditions include zoom size, font size, typeface, character code, whether or not there exists image data to be obtained, whether or not there exists sound data to be reproduced and the sound volume of the reproduced sound data, setting whether or not to output information on terminals, setting of the destination to make connection in order to obtain desired contents, and settings regarding auto-redirection and/or refresh.

It is preferable that the portable terminal according to one mode of the invention shows information indicating each output mode on an output screen. It is preferable that the information indicating each output mode is displayed in a scrolling direction on the output screen. In the portable terminal according to one mode of the invention, an output screen capable of scrolling in vertical and horizontal directions may be switched to an output screen capable of scrolling only in a vertical direction by the mode switching unit switching the output modes. Further, an output screen capable of scrolling only in a vertical direction may be switched to an output screen capable of scrolling in vertical and horizontal directions by the mode switching unit switching the output modes.

Another mode of the invention is a control method of a portable terminal capable of outputting contents over a communication network in a plurality of output modes, comprising: a step of setting output conditions for every output mode; and a step of outputting a desired content according to the output conditions set for the new output mode when the output modes are switched.

Further another mode of the invention is a portable terminal capable of outputting contents over a communication network in a plurality of output modes, comprising: means for setting output conditions for every output mode; means for switching the output modes; and means for outputting a desired content according to the output conditions set in the new output mode when the output modes are switched.

According to the invention, since the output conditions for every output mode are set and a desired content is outputted according to the output conditions set for the new output mode when the output modes are switched, it is possible to output contents over a communication network in a plurality of output modes easily.

### BRIEF DESCRIPTION OF THE DRAWINGS

FIG. 1 is a block diagram showing one embodiment of a portable terminal according to the invention.

FIG. 2 is a view showing a constitutional example of a storing area of a storing unit which stores the output conditions (parameters) set for each output mode, linking each set of conditions to respective modes.

FIG. 3 is a view showing an example of an area for displaying terminal information.

FIG. 4 is a view for use in describing an operation of the portable terminal shown in FIG. 1.

FIG. 5 is a view for use in describing another operation of the portable terminal shown in FIG. 1.

### DESCRIPTION OF THE PREFERRED EMBODIMENT(S)

The preferred embodiments will be described according to the drawings.

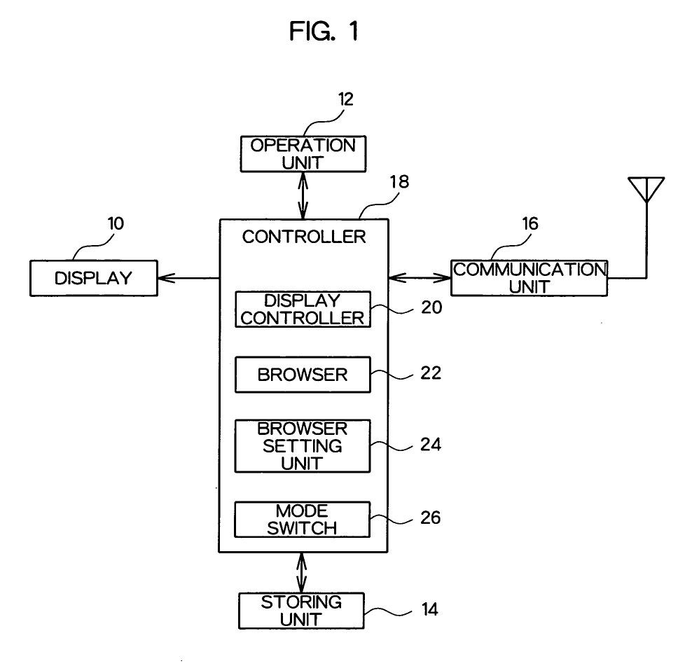

FIG. 1 is a block diagram showing the structure of a portable terminal according to one embodiment of the invention. In FIG. 1, the portable terminal comprises a display 10, an operation unit 12, a storing unit 14, a communication unit 16, and a controller 18.

The display 10 is formed by, for example, a liquid crystal display, which displays the contents input through keys such as character data and numeric data keys, various kinds of graphics, and contents produced by a browser 22 in a communication network.

The key input is performed by the operation unit 12 of FIG. 1. The operation unit 12 comprises, for example, operation buttons and the like of the portable terminal.

The storing unit 14 comprises, for example, RAM for main memory of the controller 18, EEPROM for the non-volatile memory, and a magnetic storing medium, to store the contents of the key input, various data of the output conditions of contents, and a program or the like.

The communication unit 16 realizes a telephone calling function as a portable communication terminal through communication with a base station in the known method.

The controller 18 comprises, for example, a CPU and controls the operations of the display 10, the operation unit 12, the storing unit 14, and the communication unit 16, exchanging data with these units. A display controller 20 of the controller 18 mainly controls the contents displayed on the display 10. These displayed contents include contents provided over the communication network.

The browser 22 accesses desired contents by searching the reference information describing various contents existing in the communication network, obtains the source of the desired content from a desired Web site, and converts it into display data. The content may include sound data, and in this case, the browser 22 is designed to output the sound from a sound reproducer included in the communication unit 16. The reference information may include the URL (Uniform Resource Locator) indicating the location of contents specified over the Internet.

A browser setting unit 24 performs the processing of setting output conditions for use when the browser 22 obtains output data including display data and sound data from a desired Web site and when the display controller 20 controls the display 10 to display and the sound reproducer to output the sound. Setting of each output condition is performed for each output mode.

The output modes include, for example, a portable device mode of displaying the page of a Web site which has the desired contents, in a reduced size fitting the horizontal width of a screen of the display 10, a full screen mode of displaying a page of a Web site in the original size, and a small screen mode of displaying a page of a Web site reformatted according to the size of the screen of the display 10. In the full screen mode, since the screen image displayed on the display screen of the display 10 is one portion of a page of the contents, the display controller 20 controls the displayed page so that it can be scrolled in the horizontal and vertical directions. In the portable mode and the small screen mode, since a page is contained in the display screen in the horizontal direction, the display controller 20 controls the displayed page so that it can be scrolled only in the vertical direction.

The output conditions include, for example, zoom expansion or reduction of the contents displayed on a screen, font size, typeface, character code, presence/absence of image data to be obtained when the source of a content is obtained, whether any obtained sound data is to be reproduced, sound volume for reproducing sound data, whether to display the battery remaining amount or the like, dial-up connecting destination, auto-redirection, and refresh.

A mode switch 26 of the controller 18 switches the output modes, hence to perform the respective operations.

The above controller 18 may be a computer mainly consisting of a CPU, and in this case, each function of the controller 18 is realized by the CPU running a program stored in a memory card or other media.

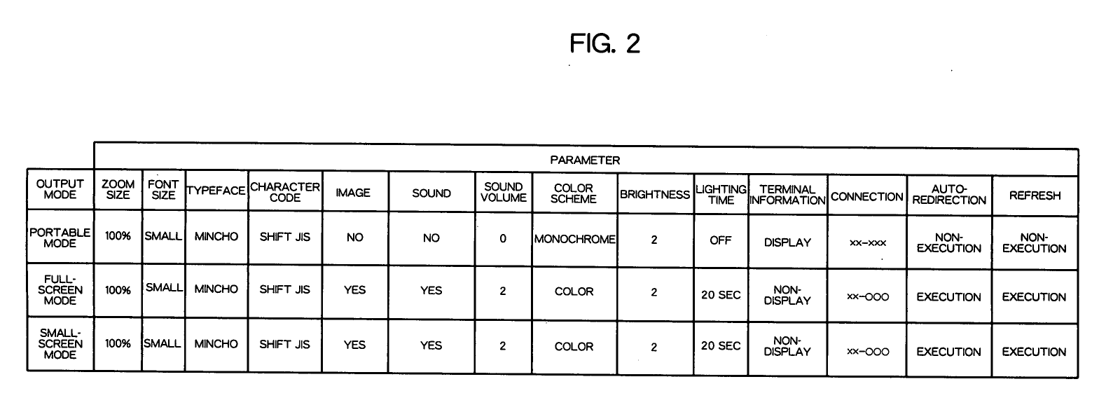

FIG. 2 shows an example of the structure of a storing area of the storing unit 14 which stores the output conditions (parameters) set for each output mode, each set of conditions linked to the respective output mode. As illustrated in FIG. 2, the parameters that are the output conditions are set for each output mode. The browser setting unit 24 sets the above parameters according to a user's input through the operation unit 12.

The zoom size shown in FIG. 2 is a parameter for deciding the degree of expanding or reducing the display contents on a screen, and when its value is 100%, the browser 22 shows the source received from the Web site without expanding or reducing. The font size is set in the browser 22, the typeface such as Gothic and Mincho or the like is set in the browser 22, and the character code such as Shift JIS, EUC, ISO, and UTF-8 or the like is set in the browser 22. The image parameter is a parameter for deciding whether the browser 22 receives image data from a Web site or not. The sound parameter is a parameter for deciding whether or not the sound data such as back ground music (BGM) shall be obtained from a Web site and reproduced, and the sound volume is a parameter for deciding the volume of the sound when the sound data is reproduced. Color scheme is a parameter for deciding whether a screen is displayed in monochrome (black and white) or color, and brightness is a parameter for deciding the brightness of the display 10, which can be chosen from a number of levels (for example, five). The lighting time is the time taken to move the brightness of the display 10 to the minimum level when the operation unit 12 doesn't have any key operation and when it is set at OFF, this function does not work. A parameter for the interval of time during which there is no operation of a key in the operation unit 12 after which the power output to the display 10 is stopped, may be provided.

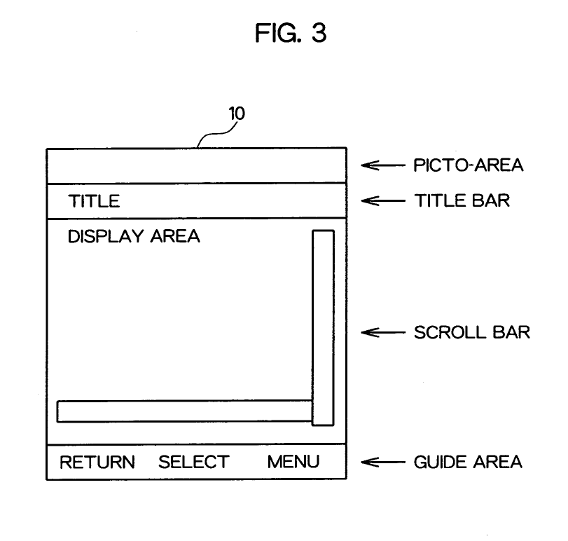

The terminal information is a parameter for deciding whether or not to display an area showing the information of a terminal such as the battery remaining amount, the time, and the state of electric field and FIG. 3 shows an example of this area. In FIG. 3, the display screen of the display 10 is provided with a picto-area, a title bar, a scroll bar, and a guide area, which help to display the terminal information. The picto-area shows the information indicating the time, the battery remaining amount, the state of electric field, and the current output mode. As the information showing the output modes, the above-mentioned full screen mode is represented by arrows in vertical and horizontal directions and the small screen mode is represented by arrows in vertical directions, correspondingly to each scroll direction of a page, so that each operation can be identified easily. At this time, the portable mode is represented by no mark or by a mark other than the above arrows.

The title bar shows the title of the page displayed currently and icons indicating various kinds of functions. At the scroll bar is shown a scale to indicate the current display position. The guide area shows the processing assigned to each key of the operation unit 12 in the current terminal state.

The connection parameters shown in FIG. 2 are those which decide the connecting destination for obtaining a desired content, such as a dial-up server. Each connecting destination can be set to be have different output modes, so that for example if an output mode is set in which the image data cannot be obtained with the above image parameter, it is possible to select a connecting destination where the communication fee is not expensive although the communication speed is low, while in the case of an output mode which can set to acquire image data, it is possible to select a connecting destination where the communication speed is high although the communication fee is expensive. Thus, connecting destinations which are suited to the respective output modes can be set ahead of time. The auto redirection/refresh is a parameter for deciding whether or not to get the browser 22 to perform the auto redirection processing or the refresh processing. The auto redirection processing done when the browser 22 requests a Web site not existing, displaying a page guiding in the search for the desired page, instead of showing an error display on the display 10. The refresh processing is the processing for once again calling up the source of the specified Web site after a predetermined elapse of time.

As mentioned above, since the parameters of the output conditions can be set separately for each output mode, it is possible to output contents over a communication network under the output conditions set for the respective output modes without necessity of changing the parameters every time the output mode of the portable terminal is switched.

The output conditions (parameter) are not restricted to the above ones shown in FIG. 2; others can be added or one of them can be deleted as necessary-.

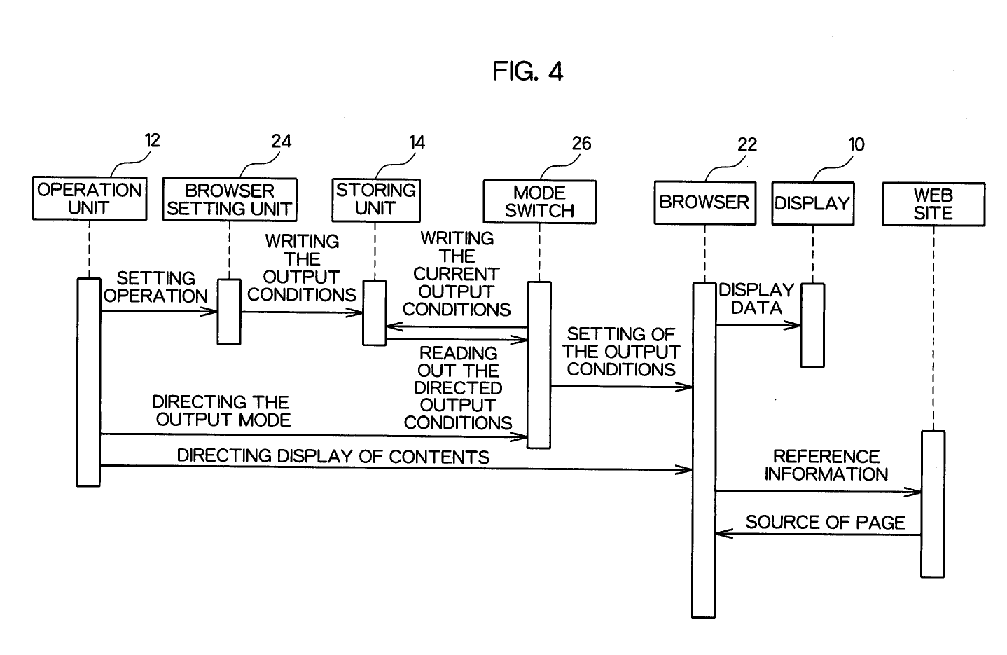

FIG. 4 is a view for use in describing an operation of the portable terminal shown in FIG. 1. In FIG. 4, when a user performs the setting operation of the output conditions corresponding to each output mode using the operation unit 12, the browser setting unit 24 stores each output condition entered from the operation unit 12 into the storing unit 14. Thus, a table such as shown in FIG. 2 is formed. The output conditions are set during the operation of a portable terminal in a certain output mode, when a user whose display 10 displays a predetermined setting screen specifies a new desired output mode shown on the setting screen.

When a user gives the operation unit 12 the instruction to display contents in a desired Web site as well as the instruction about the output mode, the mode switch 26 orders the storing unit 14 to store the output conditions corresponding to the currently set output mode, and the output conditions of the new specified output mode are read out from the storing unit 14 and set in the browser 22. In the case of a second and later display instructions in the same output mode as the currently used output mode, reading out and resetting of the output conditions may be omitted.

The browser 22 searches for desired contents by using the reference information of a designated Web site, the reference information according to the output conditions reset by the mode switch 26, and thus obtains the source of the desired Web site. The browser 22 produces the display data from the desired contents of the source based on the output conditions read from the storing unit 14, and passes it on to the display controller 20. The display controller 20 controls the display 10 to show the given display data. When there is sound data, it controls the sound reproducer to output the sound data.

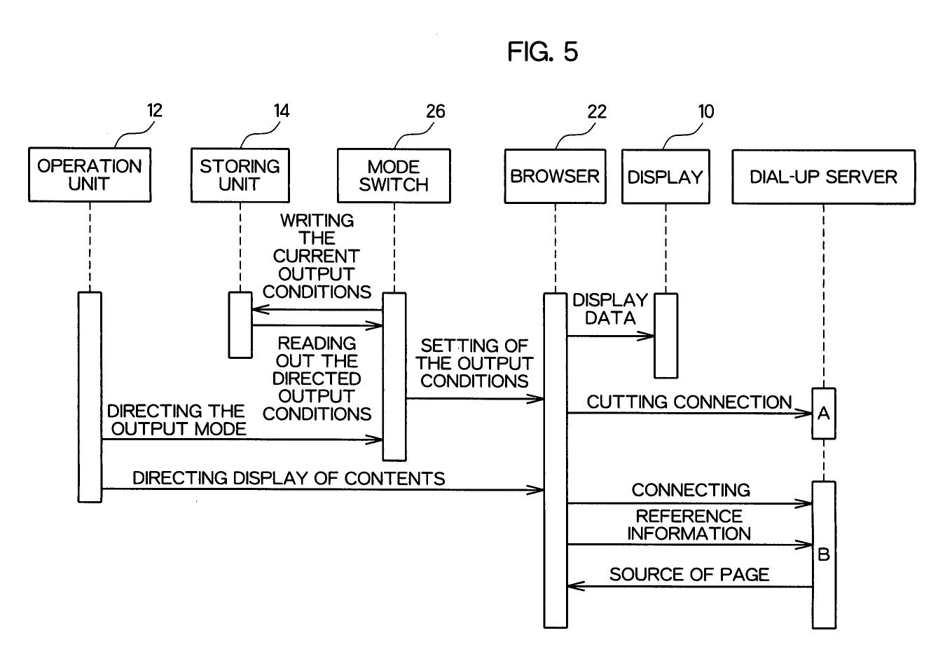

FIG. 5 is a view for use in describing another operation of the portable terminal shown in FIG. 1. In FIG. 5, the dial-up servers that are the connecting destinations are switched according to the switching of the output modes. In FIG. 5, when a user gives the operation unit 12 the instruction to display contents in a desired Web site as well as designating the output mode, the mode switch 26 orders the storing unit 14 to store the output conditions corresponding to the currently set output mode, and the output conditions of the new specified output mode are read out from the storing unit 14 and set in the browser 22. In the case of the second and later display instructions in the same output mode as the currently used output mode, reading out and resetting of the output conditions may be omitted. The browser 22 cuts off the currently connected dial-up server A and performs the processing of connecting to a dial-up server B fulfilling the output conditions reset by the mode switch 26. The browser 22 searches for the desired contents by using the reference information of a designated Web site based on the reset output conditions, and thus obtains the source of the desired Web site. The browser 22 produces the display data from the desired contents of the source based on the output conditions read out from the storing unit 14 and passes it on to the display controller 20. The display controller 20 controls the display 10 to show the given display data. When there is sound data, it controls the sound reproducer to output the sound data.

Although FIG. 5 shows the example of switching the dial-up servers, this embodiment can be used for switching the other kinds of servers, for example, www servers.

According to the structure of the above-mentioned invention, when the output mode is switched, since the desired contents are outputted according to the output conditions set for the corresponding output mode, it is not necessary to set the output conditions every time the output modes are switched, and it is possible to output contents over a communication network in a plurality of output modes with ease.

What is claimed is:

1. A portable terminal which can output contents in a communication network in a plurality of output modes, comprising:
an output condition setting unit which sets output conditions for each output mode;
a mode switching unit which switches the output modes; and
an output unit which outputs desired contents according to the output conditions set in the output mode when the output modes are switched.

2. The portable terminal according to claim 1, further comprising
a storing unit which stores the set output conditions for each output mode, in which
when the output modes are switched by the mode switching unit, the output of the contents is changed according to the output conditions stored in the storing unit.

3. The portable terminal according to claim 1, in which
the output conditions include zoom size, font size, typeface, character code, whether or not there exists image data to be obtained, whether or not there exists sound data to be reproduced, and sound volume for reproducing the sound data.

4. The portable terminal according to claim 1, in which
the output conditions include whether or not to display information on the terminal.

5. The portable terminal according to claim 1, in which
the output conditions include settings concerning the connecting destination to be accessed in order to obtain the desired contents.

6. The portable terminal according to claim 1, in which
the output conditions include settings for auto-redirection and/or refresh.

7. The portable terminal according to claim 1, in which
information indicating each output mode is displayed on an output screen.

8. The portable terminal according to claim 7, in which
the information indicating each output mode is displayed by an output showing a scrolling direction on the output screen.

9. The portable terminal according to claim 1, in which
an output screen capable of scrolling in vertical and horizontal directions is switched to an output screen capable of scrolling only in a vertical direction by the mode switching unit switching the output modes.

10. The portable terminal according to claim 1, in which
an output screen capable of scrolling only in a vertical direction is switched to an output screen capable of scrolling in vertical and horizontal directions by the mode switching unit switching the output modes.

11. A control method of a portable terminal capable of outputting contents in a communication network in a plurality of output modes, comprising:
a step of setting output conditions for each output mode; and
a step of outputting desired contents according to the output conditions set for the new output mode, when the output modes is switched.

12. A portable terminal capable of outputting contents in a communication network in a plurality of output modes, comprising:
means for setting output conditions for each output mode;
means for switching the output modes; and
means for outputting desired contents according to the output conditions set for the new output mode when the output mode is switched.
